(19) United States
(12) Patent Application Publication
(10) Pub. No.: US 2004/0180598 A1
(43) Pub. Date: Sep. 16, 2004

(54) Liquid sorbent material

(76) Inventors: Alain Yang, Bryn Mawr, PA (US); Mark Trabbold, Harleysville, PA (US); Wayne Shaw, Glen Mills, PA (US)

Correspondence Address: DUANE MORRIS, LLP, IP DEPARTMENT, ONE LIBERTY PLACE, PHILADELPHIA, PA, 19103-7396, US

(21) Appl. No.: 10/806,544

(22) Filed: Mar. 23, 2004

Related U.S. Application Data
(63) Continuation-in-part of application No. 10/689,858, filed on Oct. 21, 2003.
(63) Continuation-in-part of application No. 09/946,476, filed on Sep. 6, 2001.
(63) Continuation-in-part of application No. 10/766,052, filed on Jan. 28, 2004.
(63) Continuation-in-part of application No. 10/781,994, filed on Feb. 19, 2004.
(63) Continuation-in-part of application No. 10/782,275, filed on Feb. 19, 2004.

(51) Int. Cl. B29D 7/00; D04H 1/08; B28B 11/18; B29C 39/14; B29C 41/24; D04H 13/00; D04H 5/00; D04H 3/00; D04H 1/00; B29C 43/22; D04H 1/54; D04H 3/14; B32B 5/16; D04H 5/06

(52) U.S. Cl. 442/361; 442/362; 442/364; 442/365; 442/411; 442/415; 264/166

(57) ABSTRACT

A liquid sorbent material is made from a blend of fibrous component and plastic-containing bonding fibers. The fibrous component may be inorganic fibers, such as, scrap or virgin rotary fibers, organic fibers, or both. The plastic-containing bonding fibers may be bi-component thermoplastic polymer fibers, mono-component thermoplastic polymer fibers, thermoplastic-coated mineral fibers, or a combination thereof.

### CROSS-REFERENCE TO RELATED APPLICATIONS

This application is a continuation-in-part of the following copending U.S. patent applications: U.S. patent application Ser. No. 10/689,858, filed on Oct. 22, 2003; U.S. patent application Ser. No. 09/946,476, filed on Sep. 6, 2001; U.S. patent application Ser. No. 10/766,052, filed on Jan. 28, 2004; U.S. patent application Ser. No. 10/781,994, filed on Feb. 19, 2004; and U.S. patent application Ser. No. 10/782,275, filed on Feb. 19, 2004, which are commonly assigned and hereby incorporated by reference.

### FIELD OF THE INVENTION

The present invention relates to liquid sorbent materials and in particular to liquid sorbent materials made from inorganic fibers or other fibrous materials and plastic-containing bonding fibers.

### BACKGROUND OF THE INVENTION

Sorbent materials are useful in medical, personal hygiene and pollutant recovery applications, among others. Fibrous materials such as wools and felts, including glass fiber materials, have been used for such applications. For example, U.S. Pat. Nos. 5,215,407 and 5,078,890 (the “'407” and “'890” patent(s), respectively), for example, respectively disclose the use of loose insulation-type (i.e., unbindered) and glass fiber felt (i.e., bindered) glass fibers as means for cleaning up spills of oils and other liquid pollutants. The '407 patent discloses the use of bundles of shredded blown glass fibers for absorbing materials such as oil from water and other surfaces. The '890 patent discloses the use of felts made of mineral fibers for absorbing petroleum products from bodies of water. The felts include glass wool or rock wool, and comprise highly compressed fibers. Prior to compression, the fibers are cut into particles of less than 4 cm. The fibers are compressed with a binding agent, which is preferably of water-repellent material, thus enhancing the hydrophobicity of the felts. In another example disclosed in U.S. Pat. No. 6,180,233, commonly assigned and hereby incorporated by reference, a sorbent glass fiber material is made from a mass of unbindered, loose-fill glass fibers, or bindered glass fibers such as batting insulation, and a quantity of hydrophilic sorbent particles dispersed throughout the mass of glass fibers. The sorbent particles increase the sorbency compared to the glass fiber materials alone to improve the sorbency particulary with respect to water and aqueous liquids.

However, these existing sorbent materials are not particularly strong and are not structurally isotropic. Thus, there is a need for strong sorbent materials that are structurally isotropic for fast absorption and inexpensive to manufacture.

### SUMMARY OF THE INVENTION

According to an aspect of the present invention, a liquid sorbent material made from a blend of a fibrous component and plastic-containing bonding fibers and a method of fabricating such sorbent material are disclosed. The fibrous component may comprise, inorganic fibers, organic fibers, or both. The inorganic fibers may preferably comprise scrap rotary fibers such as shredded batting insulation. In another embodiment of the present invention, the inorganic fibers may comprise virgin rotary glass fibers, textile fibers, or unbindered loose-fill insulation-type glass fibers. The organic fibers may be other cleaned scrap fibers such as cotton, or natural fibers such as wood fibers, hemp fibers, cellulose fibers, etc. or a combination thereof. The plastic-containing bonding fibers may be bi-component polymer fibers, mono-component polymer fibers, plastic-coated mineral fibers, or a combination thereof.

As used herein, the term “sorbent” includes absorption as well as adsorption. Absorption of a liquid means that the liquid penetrates to the interior of the sorbing material, whereas adsorption of a liquid means that the liquid is attracted to and held on the surface of the sorbing material.

In another embodiment of the present invention, the sorbent material may include a quantity of hydrophilic sorbent particles dispersed throughout the fiber matrix of the sorbent material, thus forming “super-sorbent” material.

In another embodiment of the present invention, a method of making a liquid sorbent material is disclosed. In this method, inorganic or organic fibers and plastic-containing bonding fibers provided in bulk form, such as bales, are opened to obtain desired fiber sizes. The opened fibers are then evenly blended and formed into a mat having a first side and a second side. The mat is then cured or heated to form a blanket of the liquid sorbent material. The blanket may be further cut and sized or wound into rolls as desired. The method of the present invention produces liquid sorbent material having a substantially uniform density throughout its volume.

The use of scrap fibers reduces manufacturing cost because of the lower cost of the raw material compared to virgin fibers and additional cost savings may be realized by the elimination of the cost of sending the scrap fibers to landfill. In addition, recycling of the scrap fibers provides an environmentally friendly alternative to discarding the scrap fibers in landfills. Also, in an embodiment of the present invention where virgin glass fibers are used, the final product has the beneficial characteristic of being substantially formaldehyde-free because the plastic-containing bonding fibers are used as the bonding agent without the use of any formaldehyde-containing resin binders.

### BRIEF DESCRIPTION OF THE DRAWINGS

FIG. 1a is an elevational view of an exemplary embodiment of a liquid sorbent material;

FIG. 1b is a cross-sectional view of a liquid sorbent material according to another embodiment of the present invention;

FIG. 2 is a schematic illustration of an apparatus for forming the liquid sorbent material of the present invention;

FIG. 3a-3c are detailed schematic illustrations of bale openers that are part of the apparatus of FIG. 2;

FIG. 4 is a detailed schematic illustration of another section of the apparatus of FIG. 2; and

FIG. 5 is a flow chart diagram of a process for forming the exemplary liquid sorbent material of FIG. 1.

The features shown in the above referenced drawings are not intended to be drawn to scale nor are they intended to be shown in precise positional relationship. Like reference numbers indicate like elements.

### DETAILED DESCRIPTION

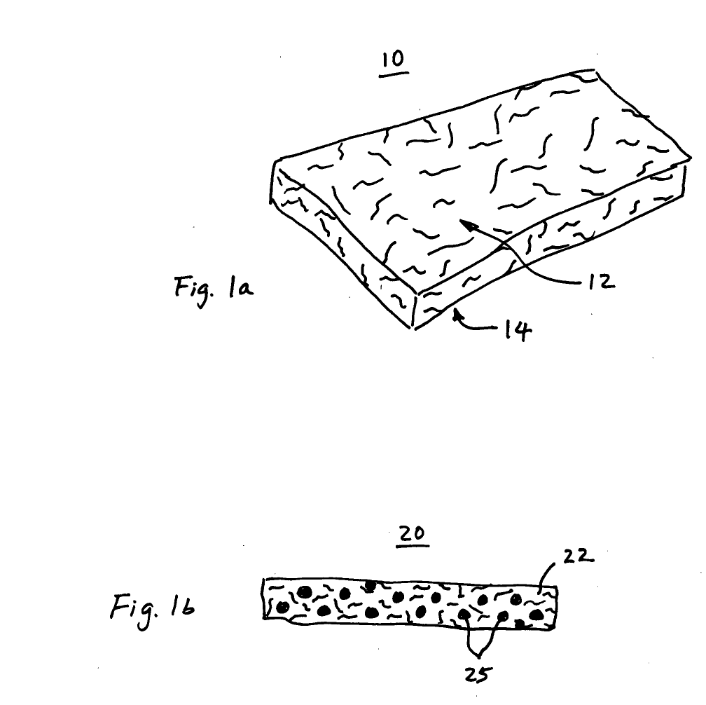

FIG. 1a is an elevational view of an exemplary liquid sorbent material 10 fabricated in a form of a cured blanket having a first side 12, a second side 14. The blanket 10 is formed from a fibrous component and plastic-containing bonding fibers. The blanket 10 may have a density of about 24 to 112 kg/m³ (1.5 to 7.0 pounds per cubic feet (pcf)) and preferably about 32 to 64 kg/m³ (2.0 and 4.0 pcf). The density of the blanket 10 is substantially uniform throughout its volume and does not have any regions that have substantially different density from the rest of the blanket. The gram weight of the blanket 10 is in the range of about 500 to 3600 gm/m2. The thickness of the cured blanket 10 may be fabricated to be in the range of about 6 to 89 mm (1 to 3.5 inches) with a desired thickness for a particular liquid sorbent product being determined by the final application.

The sorbent material formed according to the present invention has high specific surface which increases when the fiber diameter is decreased, preferably has an excellent volume recovery after compression, isotropic structure and, high tensile strength and well-bonded fiber matrix, which makes the material an ideal product for use in cleaning up marine and land-based chemical or oil spills. The sorbent material of the present invention may be used with or without any additional packaging or encapsulation fabric. In another embodiment of the present invention, the liquid sorbent material may be precut to desired size or a roll of the material may be provided with perforations to be cut into desired sizes on job site for ease of handling.

In a preferred embodiment of the present invention, the fibrous component may comprise inorganic fibers, organic fibers, or both. Preferably, the fibrous component may comprise scrap inorganic fibers such as shredded batting insulation scrap glass fibers to lower the cost of raw materials for the liquid sorbent material. The inorganic fibers may also comprise virgin rotary glass fibers, such as, loose fill insulation-type glass fibers. Virgin rotary glass fibers commercially available, for example, in the form of glass fiber insulation also may be used. These glass fibers are commonly referred to as “blown wool” insulation. Examples of suitable glass fiber materials for use according to the present invention include InsulSafe® 4 fiber glass blowing insulation available from CertainTeed Corporation of Valley Forge, Pa.; RICH-R™ blowing insulation made by Johns Manville of Denver, Colo.; and THERMACUBE™ insulation made by Owens-Corning Corp. of Toledo, Ohio. The glass fibers have an average diameter of about 0.5 to 10 micrometers, preferably about 1 to 7 micrometers, and more preferably about 2 to 6 micrometers. The average length of the glass fibers is about 1 cm or less and preferably about 2 to 3 mm. The liquid sorbent material comprises about 2 to 50 wt. %, preferably about 5 to 30 wt. %, and more preferably about 10 to 20 wt. % of the plastic-containing bonding fibers.

The fibrous component may also include organic fibers. The organic fibers may be other cleaned scrap fibers such as cotton, or natural fibers such as wood fibers, hemp fibers, cellulose fibers, etc. or a combination thereof. The diameter of the organic fibers should preferably be less than 30 micrometers with their length processed to not longer than 4 inches.

According to an aspect of the present invention, a liquid sorbent material is formed by blending a fibrous component, which may comprise inorganic or organic fibers, and plastic-containing bonding fibers. The mixture of the fibers are uniformly blended together into a mat, wherein the plastic-containing bonding fibers act as the binding agent. The mat is heated in a curing or heating oven to a temperature that is sufficiently high to soften and/or partially melt the plastic-containing bonding fibers and bond at least a portion of the glass fibers together into a cured mat or a blanket.

The plastic-containing bonding fibers used as the binder in the liquid sorbent material of the present invention may be bi-component polymeric fibers, mono-component polymeric fibers, plastic-coated mineral fibers, such as, thermoplastic-coated glass fibers, or a combination thereof. The bi-component polymeric fibers are commonly classified by their fiber cross-sectional structure as side-by-side, sheath-core, islands-in-the sea and segmented-pie cross-section types. In a preferred embodiment of the present invention, the sheath-core type bi-component polymer fibers are used.

The bi-component polymer fibers have a core material covered in a sheath material that has a lower melting temperature than the core material. Both the core and the sheath material may be a thermoplastic polymer such as, for example, nylon, polyethylene, polypropylene, polyester, polyethylene teraphthalate, polybutylene teraphthalate, polycarbonate, polyamide, polyvinyl chloride, polyethersulfone, polyphenylene sulfide, polyimide, acrylic, fluorocarbon, polyurethane, or other thermopolastic polymers. The core and the sheath materials each may be made of different thermoplastic polymers or they may be made of the same thermoplastic polymer but of different formulation so that the sheath material has lower melting point than the core material. Additionally, thermosetting resins can be employed prior to final curing or heating. Typically, the sheath material can be formulated to melt at various temperatures from about 110° to 220° Centigrade. The melting point of the core material is typically about 260° Centigrade. The bi-component polymeric fibers used in the present invention may have an average fiber diameter of about 10 to 20 micrometers and preferably about 16 micrometers. The average length of the bi-component plastic-containing bonding fibers is between about 6.3 to 127 mm and preferably between about 51 to 102 mm. The plastic-containing bonding fibers may make up about 2 to 50 wt. %, preferably about 5 to 30 wt. %, and more preferably about 10 to 20 wt. % of the insulation material.

If higher strength is desired in the final product, concentric type sheath-core bi-component polymer fibers may be used. If bulkiness is desired in the final product, eccentric type sheath-core bi-component polymer fibers may be used.

FIG. 1b is a cross-sectional illustration of another embodiment of the liquid sorbent material of the present invention. In this embodiment, the liquid sorbent material 20 may include a quantity of hydrophilic sorbent particles 25 dispersed throughout the fiber matrix 22 of the sorbent material, thus forming “super-sorbent” material. The term “super-sorbent” refers to materials that can absorb several times or more of their weight in liquid. Examples of such “super-sorbent” additives are discussed in U.S. Pat. No. 5,600,919 to Kummermehr et al. and U.S. Pat. No. 6,180,233 to Shaw, the disclosures which are incorporated herein by reference.

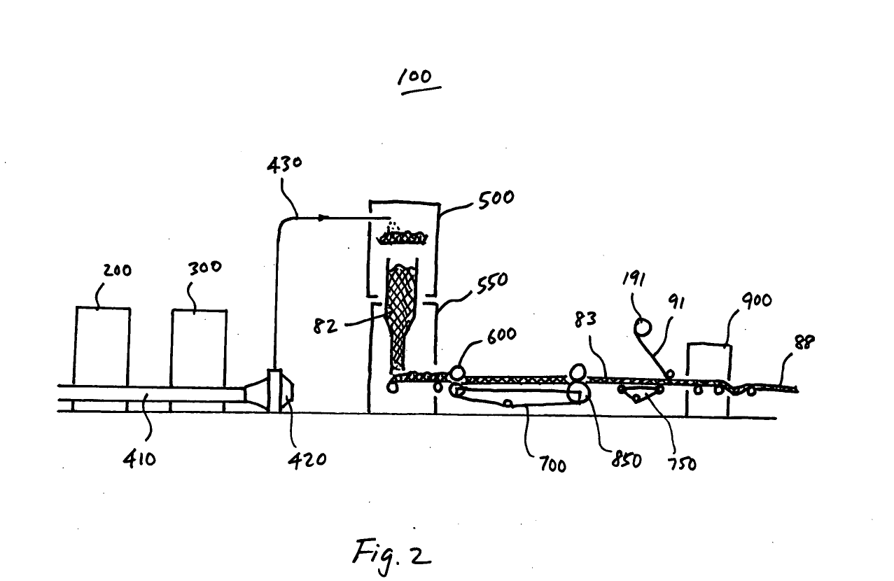

The liquid sorbent material of the present invention may be produced in accordance with air laid processing steps generally known in the art. The particular configuration of the fabrication apparatus used, however, may vary. As an example, an air laid process that may be employed in fabricating a liquid sorbent material according to an embodiment of the present invention will now be described. In a preferred method of forming the liquid sorbent material of the present invention, an air laid non-woven process equipment available from DOA (Dr. Otto Angleitner G.m.b.H. & Co. KG, A-4600 Wels, Daffingerstasse 10, Austria), equipment 100 illustrated in FIGS. 2-5, may be used. In this example, a liquid sorbent material is formed by blending building insulation scraps, and bi-component polymer fibers as the binder. As illustrated in FIG. 2, the apparatus includes bale openers 200 and 300, one for each type of fibers. The scrap glass fibers are opened by the bale opener 200 and the bi-component polymer fibers are opened by the bale opener 300. Opening decouples any clusters of fibrous masses and enhances fiber-to-fiber contact. The glass fibers and the bi-component polymer fibers are then blended uniformly according to the desired fiber ratios.

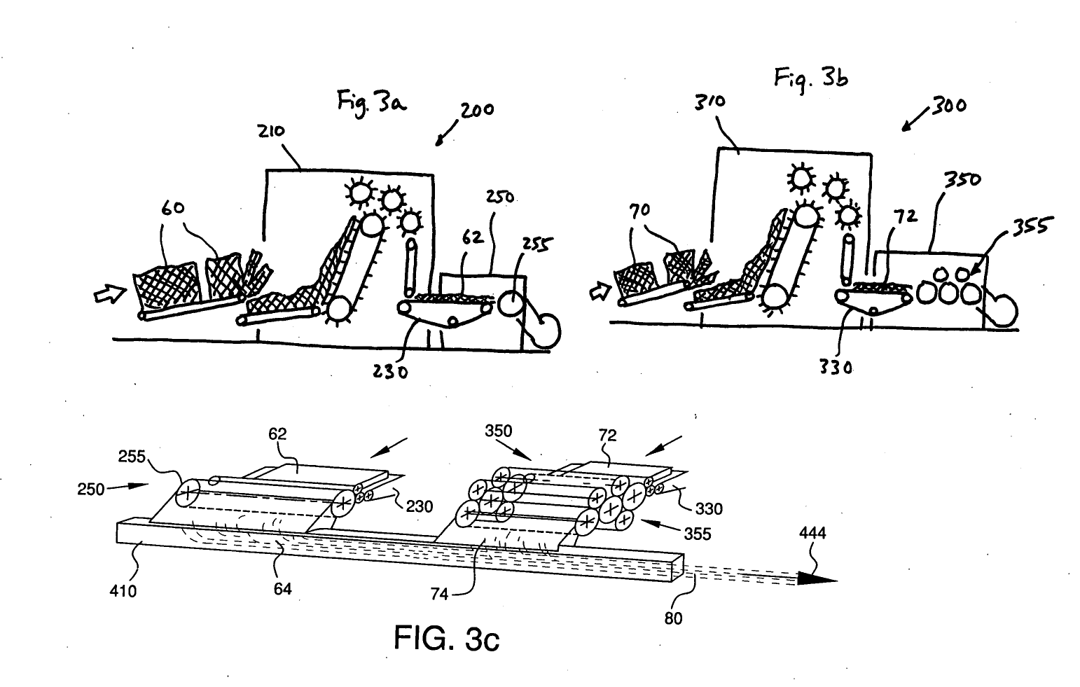

FIG. 3a is a detailed illustration of the bale opener 200. The scrap insulation glass fibers are provided in bulk form as bales 60. The bales 60 are fed into the bale opener which generally comprise coarse opener 210 and a fine opener 250. The scrap rotary glass fibers 60 are coarsely opened by the coarse opener 210 and weighed by an opener conveyor scale 230. The opener conveyor scale 230 monitors the amount of opened glass fibers being supplied to the process by continuously weighing the supply of the opened glass fibers 62 as they are being conveyed. Next, the coarsely opened glass fibers are finely opened by the fine opener's picker 255. The opening process fluffs up the fibers to decouple the clustered fibrous masses in the bales and enhances fiber-to-fiber separation.

FIG. 3b is a detailed illustration of the bale opener 300. The bi-component polymer fibers are provided in bulk form as bales 70. The bales 70 are fed into the bale opener 300. The polymer fibers 70 are first opened by a coarse opener 310 and weighed by an opener conveyor scale 330. The opener conveyor scale 330 monitors the amount of the opened plastic-containing bonding fibers being supplied to the process by continuously weighing the supply of the opened polymer fibers 72. Next, the coarsely opened polymer fibers are finely opened by the fine opener 350 and its pickers 355. For illustrative purpose, the fine opener 350 is shown with multiple pickers 355. The actual number and configuration of the pickers would depending on the desired degree of separation of the opened fibers into individual fibers. The bale openers 200 and 300 including the components described above may be provided by, for example, DOA's Bale Opener model 920/920TS.

Illustrated in FIG. 2 is a pneumatic transport system for transporting the opened fibers from the bale openers 200 and 300 to the subsequent processing stations of the apparatus 100. The pneumatic transport system comprises a transport conduit 410 in which the opened fibers are blended; an air blower 420; and a second transport conduit 430 for transporting the blended fibers up to the fiber condenser 500.

FIG. 3c illustrates opened scrap rotary glass fibers 64 and opened bi-component polymer fibers 74 being discharged into the first transport conduit 410 from their respective fine openers 250 and 350. The airflow in the first transport conduit 410 generated by the air blower 420 is represented by the arrow 444. The opened fibers 64 and 74 enters the air stream and are blended together into blended fibers 80. The ratio of the glass fibers and the bi-component polymer fibers are maintained and controlled at a desired level by controlling the amount of the fibers being opened and discharged by the bale openers using the opener conveyor scales 230 and 330. As mentioned above, the conveyor scales 230, 330 continuously weigh the opened fiber supply for this purpose. In this example, the fibers are blended in a given ratio to yield the final insulation mat containing about 10 to 20 wt. % of the plastic-containing bonding fibers.

Although one opener per fiber component is illustrated in this exemplary process, the actual number of bale openers utilized in a given process may vary depending on the particular need. For example, one or more bale openers may be employed for each fiber component.

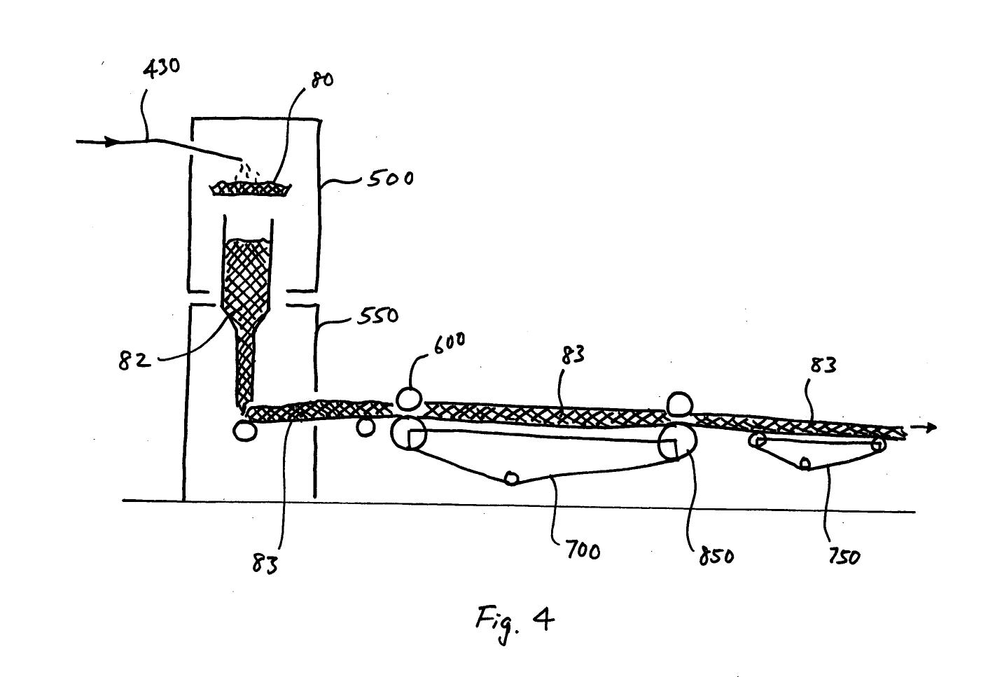

The blended fibers 80 are transported by the air stream in the pneumatic transport system via the second transport conduit 430 to a fiber condenser 500. Referring to FIG. 4, the fiber condenser 500 condenses the blended fibers 80 into less airy fiber blend 82. The condensing process only separates air from the blend without disrupting the uniformity (or homogeneity) of the blended fibers. The fiber blend 82 is then formed into a continuous feed of mat 83 by the feeder 550. At this point, the mat 83 may be optionally processed through a sieve drum sheet former 600 to adjust the openness of the fibers in the mat 83. The mat 83 is then transported by another conveyor scale 700 during which the mat 83 is continuously weighed to ensure that the flow rate of the blended fibers through the fiber condenser 500 and the feeder 550 is at a desired rate. The conveyor scale 700 is in communication with the first set of conveyor scales 230 and 330 in the bale openers. Through this feed back loop set up, the weight of the opened fibers measured at the conveyor scales 230 and 330 are compared to the weight of the mat 83 measured at the conveyor scale 700 to determine whether the amount of the opened fibers being fed into the process at the front end matches the rate at which the mat 83 is being formed at the feeder 550. Thus, the feed back loop set up effectively compares the feed rate of the opened fibers and the flow rate of the blended fibers through the feeder 550 and adjusts the speed of the bale openers and the rate at which the bales are being fed into the openers. This ensures that the bale openers 200 and 300 are operating at appropriate speed to meet the demand of the down stream processing. This feed back loop set up is used to control and adjust the feed rate of the opened fibers and the line speed of the conveyor scale 700 which are the primary variables that determine the gram weight of the mat 83. The air laid non-woven process equipment 100 may be provided with an appropriate control system (not shown), such as a computer, that manages the operation of the equipment including the above-mentioned feed back loop function.

A second sieve drum sheet former 850 may be used to further adjust the fibers' openness before curing or heating the mat 83. A conveyor 750 then transports the mat 83 to a curing or heating oven 900 (FIG. 2). For example, the condenser 500, feeder 550, sieve drum sheet former 600, conveyor scale 700, and the second sieve drum sheet former 850 may be provided using DOA's Aerodynamic Sheet Forming Machine model number 1048.

The mat 83 is then fed into a curing or heating oven 900 to cure the plastic-containing bonding fibers. The curing or heating oven 900 is preferably a belt-furnace type. The curing or heating temperature is generally set at a temperature that is higher than the curing or melting temperature of the binder material. In this example, the curing or heating oven 900 is set at a temperature higher than the melting point of the sheath material of the bi-component polymeric fibers but lower than the melting point of the core material of the bi-component polymeric fibers. In this example, the bi-component polymer fibers used is Celbond type 254 available from KoSa of Salisbury, N.C., whose sheath has a melting point of 110° C. And the curing or heating oven temperature is preferably set to be somewhat above the melting point of the sheath material at about 145° C. The sheath component will melt and bond at least a portion of the glass fibers and the remaining core filament of the bi-component polymeric fibers together into a final mat 88 having a substantially uniform density throughout its volume. The core component of the bi-component polymeric fibers in the final mat 88 provide reinforcement for the insulation product formed from the final mat 88.

In another embodiment of the present invention, the curing or heating oven 900 may be set to be at about or higher than the melting point of the core component of the bi-component polymeric fiber. This will cause the bi-component fibers to completely or almost completely melt and serve generally as a binder without necessarily providing reinforcing fibers. Because of the high fluidity of the molten plastic fibers, the glass fiber mat will be better covered and bounded. Thus, less plastic-containing bonding fibers may be used.

In another embodiment of the present invention, mono-component polymeric fibers may be used as the binder rather than the bi-component polymeric fibers. The mono-component polymeric fibers used for this purpose may be made from the same polyolefin thermoplastic polymers as the bi-component polymeric fibers. The melting point of various mono-component polymeric fibers will vary and one may choose a particular mono-component polymeric fiber to meet the desired curing or heating temperature needs. Generally, the mono-component polymeric fibers will completely or almost completely melt during the curing or heating process step and bind the glass fibers.

In yet another embodiment of the present invention, plastic coated glass fibers may be used as the bonding fibers instead of, or in combination with, the bi-component polymer fibers. Still in another embodiment of the present invention, scraps of commingled glass and thermoplastic fibers such as Twintex® available from Saint-Gobain Vetrotex International, S.A. may be used as the mineral fiber component, the bonding fiber component, or used in combination with other mineral fibers and the plastic-containing bonding fibers.

After curing or heating, a series of finishing operations may be performed. The final mat 88 exiting the curing or heating oven 900 is cooled in a cooling section (not shown) and may be cut to desired sizes.

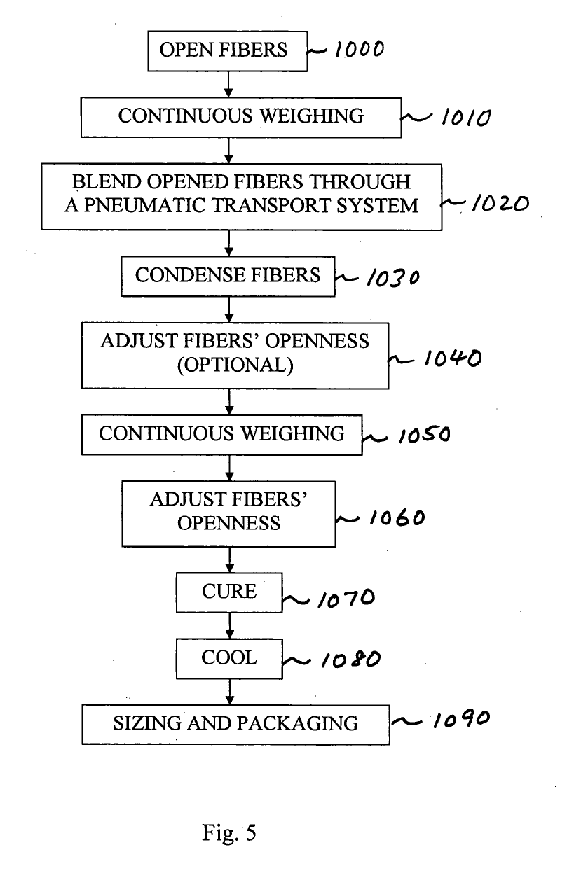

FIG. 5 is a flow chart diagram of the exemplary process.

At step 1000, the bales of the inorganic or organic fibers and plastic-containing bonding fibers are opened using bale openers.

At step 1010, the opened fibers are weighed continuously by one or more conveyor scale(s) to monitor the amount of fibers being opened to control the amount of each type of fibers being supplied to the process ensuring that the fibers are being blended in a proper ratio.

At step 1020, the opened fibers are blended and transported to the fiber condenser by a pneumatic transport system which blends and transports the opened fiber(s) in an air stream through a conduit.

At step 1030, the opened fibers are condensed into less airy fiber blend and formed into a continuously feeding sheet (a mat) and uniformly laid out on to a conveyor.

At step 1040, the condensed fiber blend is optionally processed through a sieve drum sheet former to adjust the openness of the fibers in the mat.

At step 1050, the mat is continuously weighed by a conveyor scale to ensure that the flow rate of the blended fibers through the fiber condenser and the sheet former is at a desired rate. The information from this conveyor scale is fed back to the first set of conveyor scale(s) associated with the bale openers to control the bale opener(s) operation. The conveyor scales ensure that a proper supply and demand relationship is maintained between the bale opener(s) and the fiber condenser and sheet former.

At step 1060, the fibers' openness may be further adjusted by a second sieve drum sheet former.

At step 1070, the mat is cured or heated in a belt-furnace type curing or heating oven. The curing or heating oven is set at a temperature appropriate for curing or melting the particular plastic-containing bonding fibers used. Generally, this temperature will be somewhat higher than the curing or melting temperature of the bonding fibers.

At step 1080, the cured mat is cooled.

At step 1090, the cured mat may be cut to desired sizes and packaged for shipping.

The use of the plastic-containing bonding fibers as the binder rather than the conventional resin binders is beneficial for a number of reasons. Because the curing or heating temperature for plastic-containing bonding fibers is generally lower than that of the conventional phenol resin binders, the manufacturing process associated with the liquid sorbent material of the present invention consumes less energy. For example, the curing or heating ovens used in the manufacturing process described above in reference to FIGS. 3-4, are set to be less than about 200° C. and preferably at about 145° C. rather than about 205° C. or higher typically required for curing phenol resin binders. Also, because of the absence of formaldehyde out gassing from the binder material during the fabrication process, there is no need for special air treatment equipment to remove formaldehyde from the curing or heating oven's exhaust. These advantages translate into lower manufacturing cost and less air pollution.

Furthermore, unlike the thermosetting phenol resin binders, that are rigid and brittle when cured, the plastic-containing bonding fibers are thermoplastic polymers and are more flexible and less likely to crack and generate dust through handling.

While the foregoing invention has been described with reference to the above embodiments, various modifications and changes can be made without departing from the spirit of the invention. Accordingly, all such modifications and changes are considered to be within the scope of the appended claims.

What is claimed is:

1. A liquid sorbent material comprising:
a plurality of first fibers forming a fiber component; and
plastic-containing bonding fibers, said fiber component bonded together by a portion of the plastic of said plastic-containing bonding fibers.

2. The liquid sorbent material of claim 1, wherein said fiber component and the plastic-containing bonding fibers are uniformly blended.

3. The liquid sorbent material of claim 1, wherein said plurality of first fibers comprise inorganic fibers, organic fibers, or both.

4. The liquid sorbent material of claim 1, wherein said plurality of first fibers comprise inorganic fibers comprising scrap rotary glass fibers, virgin rotary glass fibers, or both.

5. The liquid sorbent material of claim 1, wherein said plurality of first fibers comprise organic fibers comprising cleaned scrap cotton fibers, wood fibers, hemp fibers, cellulose fibers, or a combination thereof.

6. The liquid sorbent material of claim 1, wherein said liquid sorbent material has a substantially uniform density throughout its volume.

7. The liquid sorbent material of claim 6, wherein said density of the liquid sorbent material is about 24 to 112 kg/m³.

8. The liquid sorbent material of claim 1, wherein said density of the liquid sorbent material is about 32 to 64 kg/m³.

9. The liquid sorbent material of claim 1, wherein said liquid sorbent material has a gram weight of about 500 to 3600 gm/m².

10. The liquid sorbent material of claim 1, wherein the liquid sorbent material has a gram weight of about 600 to 3000 gm/m².

11. The liquid sorbent material of claim 1, wherein said liquid sorbent material has a thickness of about 6 to 89 mm.

12. The liquid sorbent material of claim 4, wherein said inorganic fibers have an average diameter of about 0.5 to 10 micrometers.

13. The liquid sorbent material of claim 4, wherein said inorganic fibers have an average diameter of about 1 to 7 micrometers.

14. The liquid sorbent material of claim 4, wherein said inorganic fibers have an average diameter of about 2 to 6 micrometers.

15. The liquid sorbent material of claim 4, wherein said inorganic fibers have an average length of no more than 1 cm.

16. The liquid sorbent material of claim 4, wherein said inorganic fibers have an average length of about 2 to 3 mm.

17. The liquid sorbent material of claim 1, wherein said liquid sorbent material comprises about 2 to 50 wt. % of said plastic-containing bonding fibers.

18. The liquid sorbent material of claim 1, wherein said liquid sorbent material comprises about 5 to 30 wt. % of said plastic-containing bonding fibers.

19. The liquid sorbent material of claim 1, wherein said liquid sorbent material comprises about 10 to 20 wt. % of said plastic-containing bonding fibers.

20. The liquid sorbent material of claim 1, wherein said plastic-containing bonding fibers comprise bi-component fibers.

21. The liquid sorbent material of claim 20, wherein said bi-component fibers are sheath-core, side-by-side, island-in-the-sea, or segmented-pie cross-section type.

22. The liquid sorbent material of claim 20, wherein said bi-component fibers comprise:
a core material; and
a sheath material, wherein said sheath material has a melting point temperature lower than the melting point temperature of said core material.

23. The liquid sorbent material of claim 22, wherein said core material and said sheath material are both thermoplastic polymers.

24. The liquid sorbent material of claim 22, wherein said core material is a mineral and said sheath material is a thermoplastic polymer.

25. The liquid sorbent material of claim 22, wherein said core material and said sheath material are same thermoplastic polymer but of different formulations.

26. The liquid sorbent material of claim 1, wherein said plastic-containing bonding fibers comprise mono-component thermoplastic polymer fibers.

27. The liquid sorbent material of claim 1, further comprising a quantity of hydrophilic sorbent particles dispersed throughout the liquid sorbent material.

28. A method of making a liquid sorbent material, comprising the steps of:
opening bulk first fibers and bulk second plastic-containing bonding fibers;
blending said opened first fibers and said second plastic-containing bonding fibers into blended fibers;
forming said fiber blend into a mat having a first side and a second side;
curing or heating said mat into said liquid sorbent material.

29. The method of claim 28, wherein said first fibers comprise inorganic fibers comprising scrap rotary glass fibers, virgin rotary glass fibers, or both

30. The method of claim 28, wherein said step of opening further comprises a step of weighing the opened fibers to monitor the feed rate of the opened fibers.

31. The method of claim 30, wherein said step of forming said fiber blend into said mat further comprising continuously weighing said mat to ensure that said flow rate of the blended fibers is at a desired rate.

32. The method of claim 31, further comprising a step of comparing the feed rate of said opened fibers and the flow rate of said blended fibers in a feed back loop to control the speed of said opening step.

33. The method of claim 28, wherein said curing or heating step comprises curing or heating said mat at a temperature of less than about 200° C.

34. A method of absorbing a liquid spill, comprising:
(a) providing a sorbent material comprising a plurality of inorganic fibers uniformly blended and bonded by plastic-containing bonding fibers; and
(b) contacting said sorbent material with said liquid spill, whereby said sorbent material absorbs a quantity of said liquid.

35. The method of claim 34, wherein said liquid is oil.
